(19) United States
(12) Patent Application Publication
(10) Pub. No.: US 2014/0208625 A1
(43) Pub. Date: Jul. 31, 2014

(54) Multi-Attachment Label Holder

(71) Applicant: Mary Kirby, Beloit, WI (US)

(72) Inventor: Mary Kirby, Beloit, WI (US)

(73) Assignee: Southern Imperial, Inc., Rockford, IL (US)

(21) Appl. No.: 13/750,302

(22) Filed: Jan. 25, 2013

(51) Int. Cl. G09F 3/16

(52) U.S. Cl. CPC G09F 3/16
USPC 40/658

(57) ABSTRACT

An information display apparatus is provided. The information display apparatus is configured to display information in a retail setting. A label holder may be configured to be coupled to multiple different types of displays. The label holder may display information regarding merchandise for sale.

### FIELD OF THE INVENTION

This invention generally relates to the field of retail sales and more particularly to holders for labels in a retail sales environment.

### BACKGROUND OF THE INVENTION

Merchandise for sale may be displayed using various types of displays in a retail setting. Additionally, information regarding merchandise for sale may be displayed proximate the merchandise for sale.

### BRIEF SUMMARY OF THE INVENTION

One embodiment of a label holder includes a label portion. The label portion includes a display side configured to display a label and an attachment side. The label holder includes a first coupling portion extending from the attachment side of the label portion. The first coupling portion is configured to couple the label holder to a first display. The label holder includes a second coupling portion. The second coupling portion extends from the attachment side of the label portion. The second coupling portion is configured to couple the label holder to a second display. The second display is different from the first display.

Another embodiment of a label holder includes a label portion. The label holder includes a first coupling portion extending from the label portion. The label holder includes a second coupling portion extending from the label portion to an end wall. The first coupling portion includes a first clip portion and a second clip portion spaced apart from the first clip portion. The first and second clip portions define a first gap therebetween. The first clip portion defines a first channel. The second clip portion defines a second channel generally aligned with the first channel. The second coupling portion defines a third channel extending along a first axis generally perpendicular to the label portion from the label portion to a first aperture in the end wall. The second coupling portion defines a fourth channel extending from the third channel proximate the label portion and extending along a second axis generally parallel with the label portion.

An embodiment of a method of providing multiple display arrangements includes providing a first display. The first display includes a first portion and a coupling portion extending generally perpendicularly to the first portion. The coupling portion extends from a first end on a left side of the first portion to a second end located on a right side of the first portion. The method includes providing a second display. The second display includes a first portion and a second portion extending generally perpendicularly to the first portion. The second portion extends from a first end proximate the first portion to a second end distal from the first portion. The method includes providing a label holder configured to support a label. The label holder has a first coupling portion and a second coupling portion. The first coupling portion includes a clip configured to receive the coupling portion of the first display. The second coupling portion defines a first channel and a second channel. The first channel is configured to receive the first portion of the second display. The second channel is configured to receive the second portion of the second display. The method includes locating the coupling portion of the first display in the clip to couple the label holder to the first display. The method includes removing the label holder from the first display. The method includes locating the first portion of the second display in the first channel of the second coupling portion and locating the second portion of the second display in the second channel of the second coupling portion to couple the label holder to the second display.

Alternative exemplary embodiments relate to other features and combinations of features as may be generally recited in the claims.

### BRIEF DESCRIPTION OF THE DRAWINGS

This application will become more fully understood from the following detailed description, taken in conjunction with the accompanying figures, wherein like reference numerals refer to like elements in which:

FIG. 1 is a perspective view of an embodiment of a display arrangement including an embodiment of a label holder coupled to a first display;

FIG. 2 is a perspective view of another embodiment of a display arrangement including the embodiment of the label holder of FIG. 1 coupled to a second display;

FIG. 3 is a perspective view of another embodiment of a display arrangement including the embodiment of the label holder of FIGS. 1 and 2 coupled to a third display;

FIG. 4 is a left side rear perspective view of an embodiment of a label holder;

FIG. 4A is perspective view of an embodiment of a label holder;

FIG. 4B is a right side rear perspective view of an embodiment of a label holder;

FIG. 5 is an exploded view of an embodiment of a label holder and the first display of FIG. 1;

FIG. 5A is a rear perspective view of an embodiment of a label holder coupled to the first display of FIG. 1;

FIG. 5B is a side view of the label holder of FIG. 5A rotatively displaced about the coupling portion of the first display;

FIG. 5C is a side view of the label holder of FIG. 5B coupled to the coupling portion of the first display with the label holder in a down configuration;

FIG. 6 is an exploded view of the label holder of FIGS. 5-5B and the third display of FIG. 3;

FIG. 6A is a detail view of the label holder and a portion of the third display of FIG. 6;

FIG. 6B is a rear perspective view of the label holder of FIGS. 5-5B coupled to the third display of FIG. 3;

FIG. 7 is a left side view of an embodiment of a label holder;

FIG. 7A is a right side view of an embodiment of a label holder;

FIG. 7B is a rear view of an embodiment of a label holder;

FIG. 8 is an exploded view of the label holder of FIGS. 5-5B, 6, and 6A and two embodiments of a second display;

FIG. 8A is an exploded view of the label holder of FIGS. 5-5B, 6, and 6A and two embodiments of a second display;

FIG. 9 is a rear perspective view of the label holder of FIGS. 5-5B, 6, and 6A coupled to the second display of FIG. 2;

FIG. 9A is a rear perspective view of the label holder of FIGS. 5-5B, 6, and 6A coupled to the second display of FIG. 2;

FIG. 10 is a front view of an embodiment of a label holder;

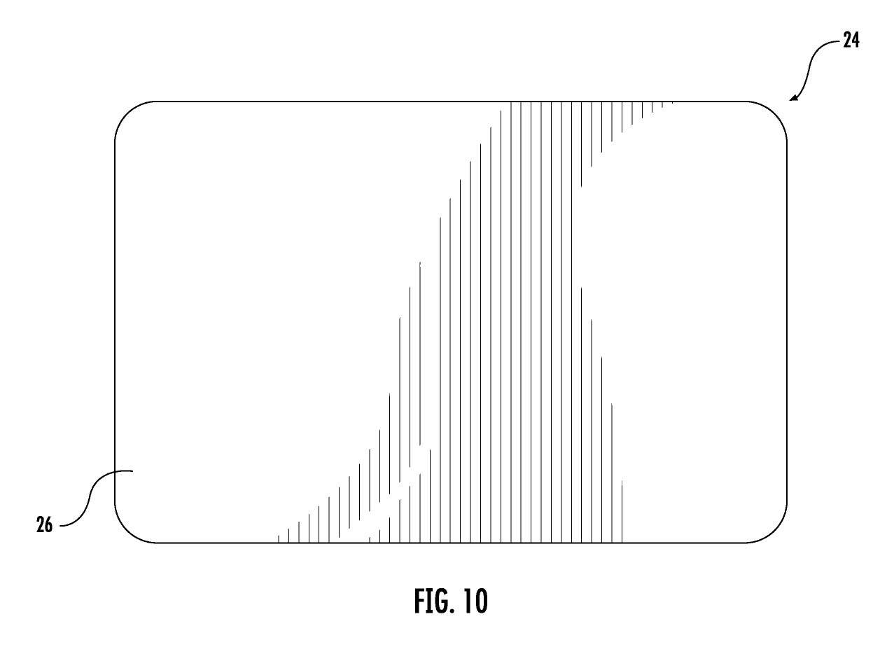

FIG. 11 is a top view of an embodiment of a label holder;

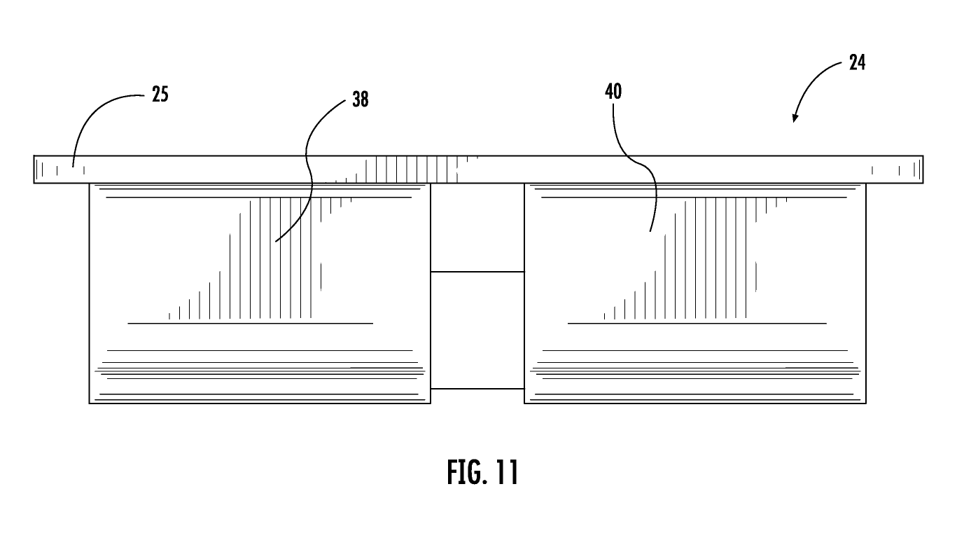

FIG. 12 is a bottom view of an embodiment of a label holder; and

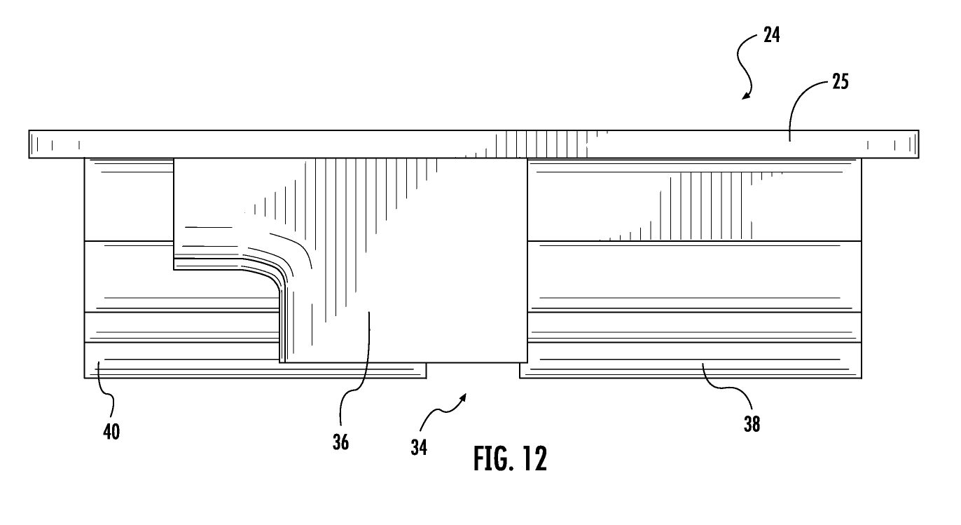

FIG. 13 is another embodiment of a label holder coupled to a display.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

Additionally, before turning to the figures, in retail sales locations, products for sale are often displayed in various manners using various displays, e.g., display apparatuses. In some situations it may be advantageous to provide information related to the products for sale proximate the products, e.g., coupled to the display apparatuses. Display apparatuses may be of various constructions, shapes, etc., for example for different types of products, different display configurations, etc. It may be advantageous to provide a mechanism for providing information configured to be coupled to various different types, shapes, configurations, sizes, etc., of display apparatuses. Such a mechanism may eliminate the need for a retail sales location to obtain and keep different and/or specialized information holders to couple to each different type of display apparatus.

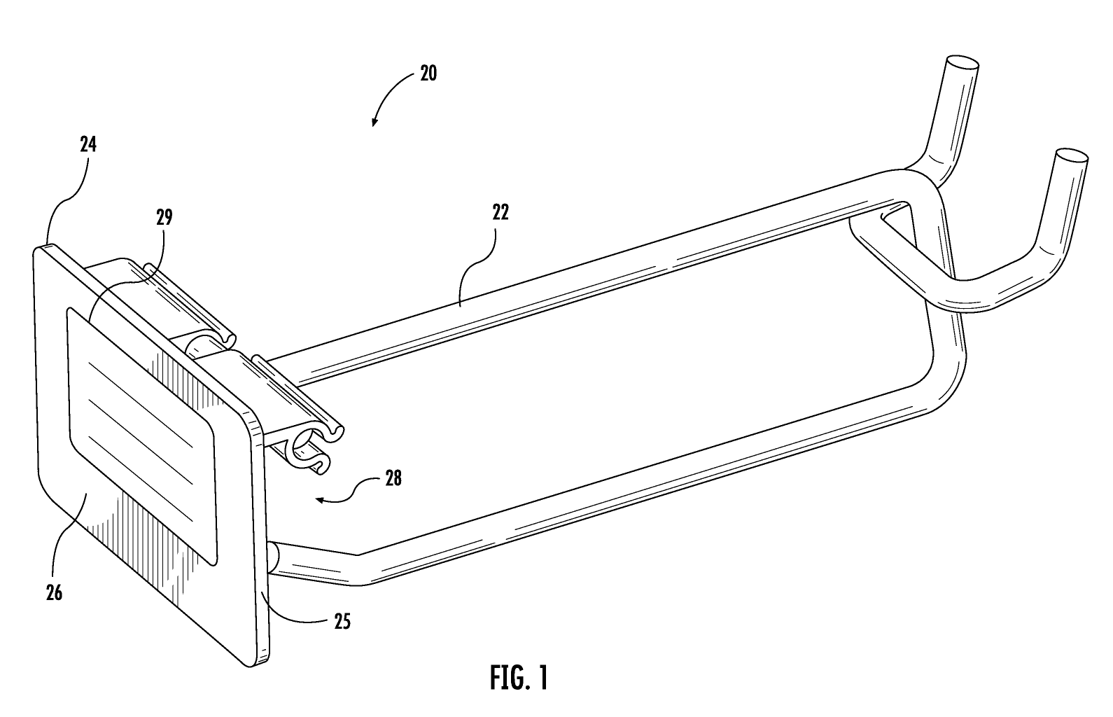

With reference to FIG. 1, an embodiment of a display and label arrangement 20 is illustrated. The arrangement 20 includes a display, illustrated in FIG. 1 as a wire hook 22 and an embodiment of an information displaying apparatus, illustrated in FIG. 1 as a label holder 24. The label holder 24 includes a label holding portion, illustrated as plate portion 25 in FIG. 1, with a display side 26 and an attachment side 28. The display side 26 is configured such that customers may view the display side to see information such as, e.g., product information. The attachment side 28 includes attachment features configured to couple the label holder 24 to a display such as the wire hook 22, as will be discussed further below. In one embodiment, information may be displayed for example by coupling a label 29 including indicia indicative of information to the plate portion 25. In various embodiments, displayed information may include information regarding the product displayed on the wire hook 22, e.g., price information, origin information, advertisements, specials, details regarding the product, etc. In one embodiment, a label may be removably or irremovably coupled to display side 26 by any suitable mechanism, e.g., adhesive, fasteners, etc.

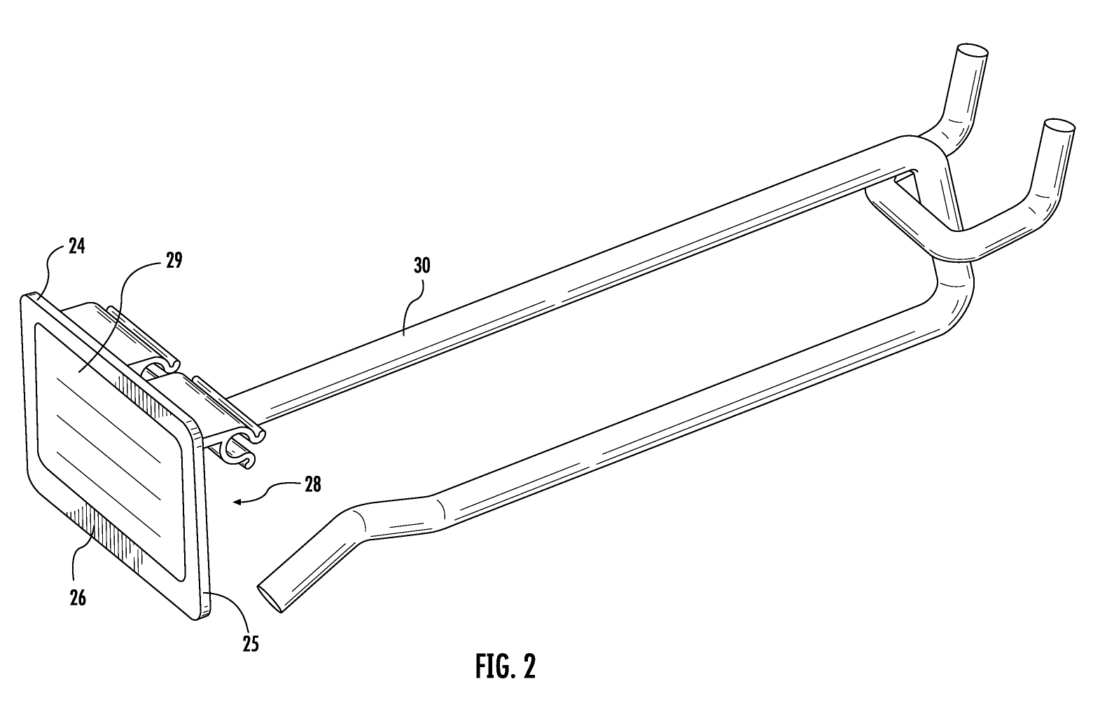

With reference to FIG. 2, the embodiment of the label holder 24 of FIG. 1 is illustrated coupled to another display, illustrated in FIG. 2 as another embodiment of a wire hook 30, as will be further described below.

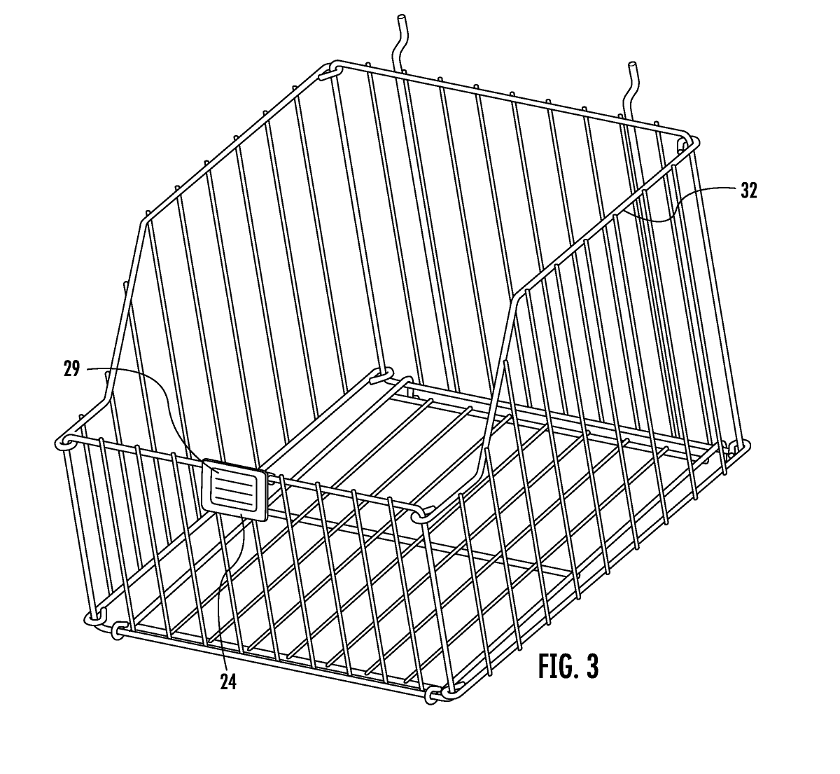

With reference to FIG. 3, the embodiment of the label holder 24 of FIGS. 1 and 2 is illustrated coupled to another display, illustrated in FIG. 3 as a wire basket 32 configured to hold product for sale.

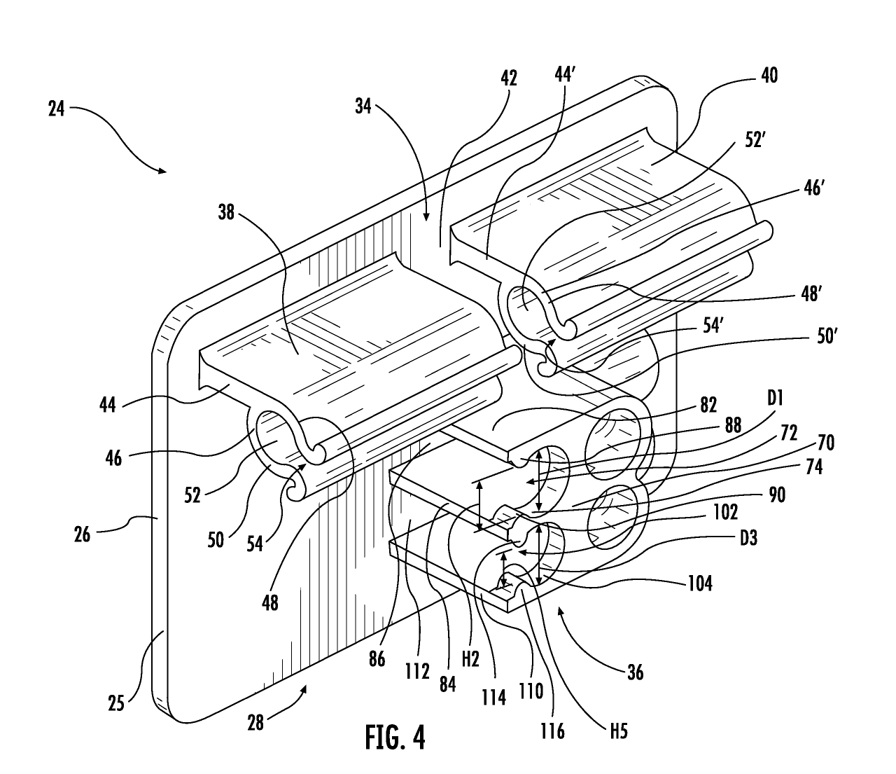

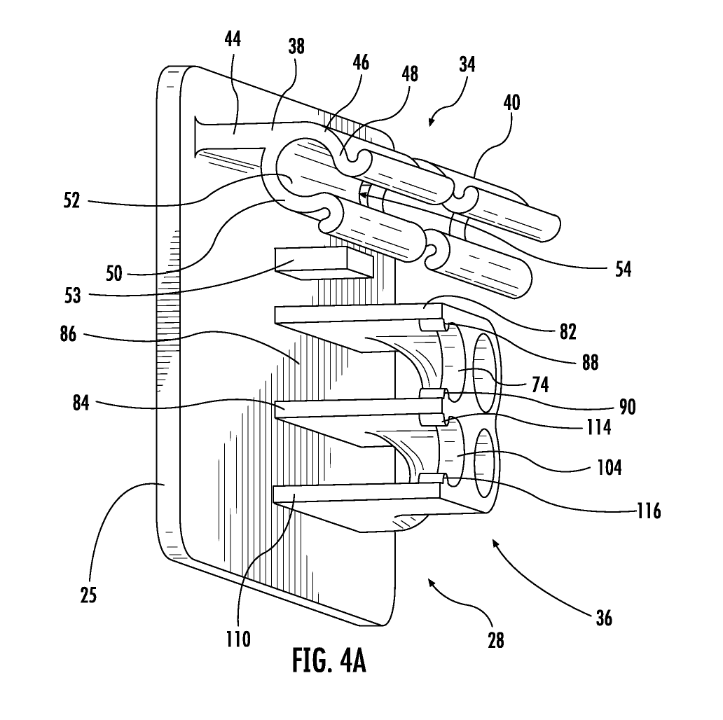

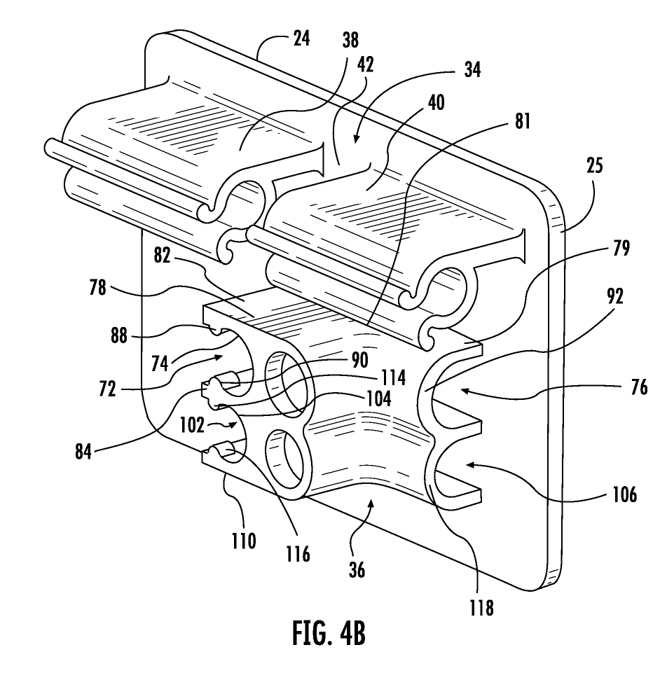

With reference to FIGS. 4 and 4A, the coupling side 28 of a plate portion 25 of an embodiment of a label holder 24 is illustrated. The label holder 24 includes a first coupling portion 34 and a second coupling portion 36 each extending from the coupling side 28 of the plate portion 25. The second coupling portion 36 is configured to couple the label holder 24 to a different type of display than the first coupling portion 34.

With further reference to FIGS. 4 and 4A, in one embodiment, the first coupling portion 34 includes a left clip 38 and a right clip 40 spaced apart from the left clip 38, the left and right clips 38 and 40 defining a gap 42 therebetween. In one embodiment, the gap 42 is located generally horizontally centered relative to the plate portion 25. In one embodiment, the left and right clips 38 and 40 are substantially identical and each include a wall portion 44 and 44′ extending away from the plate portion 25 generally perpendicular to the plate portion 25. The clips 38 and 40 each also include a generally C-shaped clip portion 46 and 46′. The clip portions 46 and 46′ each include an upper leg 48 and 48′ and a lower leg 50 and 50′ extending from the wall portion 44 distal from the plate portion 25. The upper and lower legs 48 and 50 of the left clip 38 define a left channel 52 therebetween. Similarly, in one embodiment, the upper and lower legs 48′ and 50′ of the right clip 40 define a right channel 52′ therebetween. In one embodiment, the left 52 and right 52′ channels are substantially aligned. In one embodiment, there is a gap 54 between the upper 48 and lower 50 legs distal from the wall portion 44. Similarly, in one embodiment, there is a gap 54′ between the upper 48′ and lower 50′ legs distal from the wall portion 44′. In one embodiment, the legs 48 and 50 may be displaced away from each other to allow a portion of a display to be located in the channel 52. In one embodiment, the legs 48 and 50 are biased to return toward their original configuration toward one another, tending to retain the portion of the display in the channel 52. Similarly, in one embodiment, the legs 48′ and 50′ may be displayed away from each other to allow a portion of a display to be located in the channel 52′. In one embodiment, the legs 48′ and 50′ are biased to return toward their original configuration toward one another, tending to retain the portion of the display in the channel 52′.

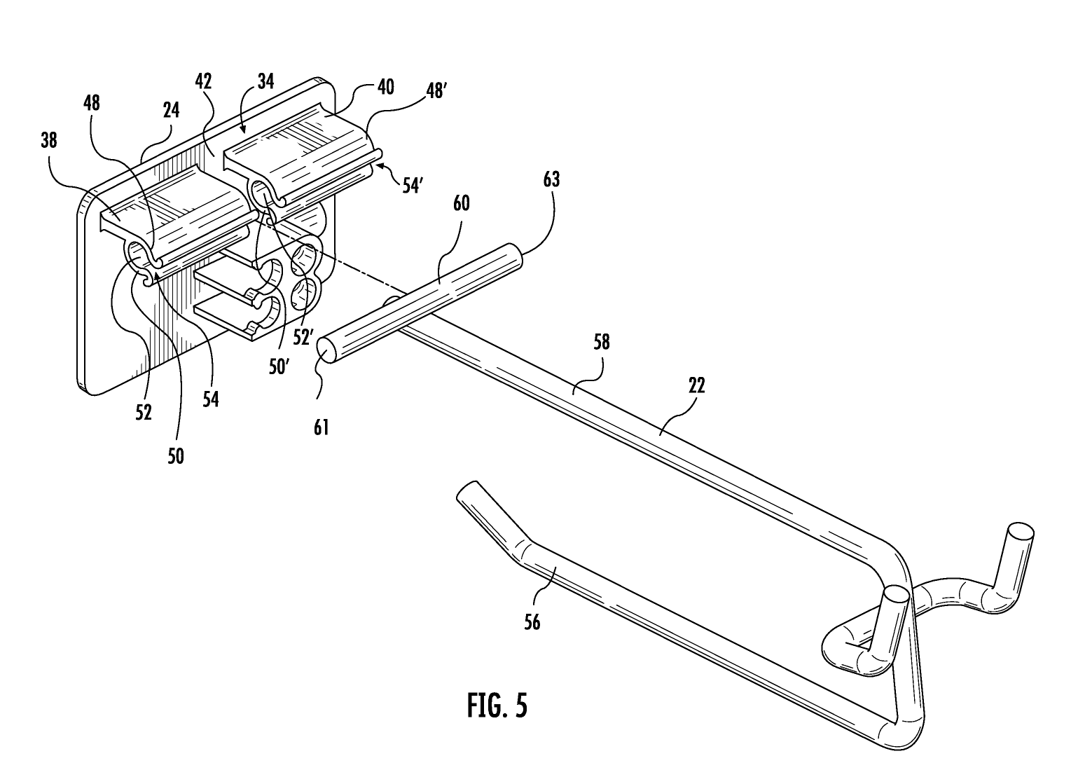

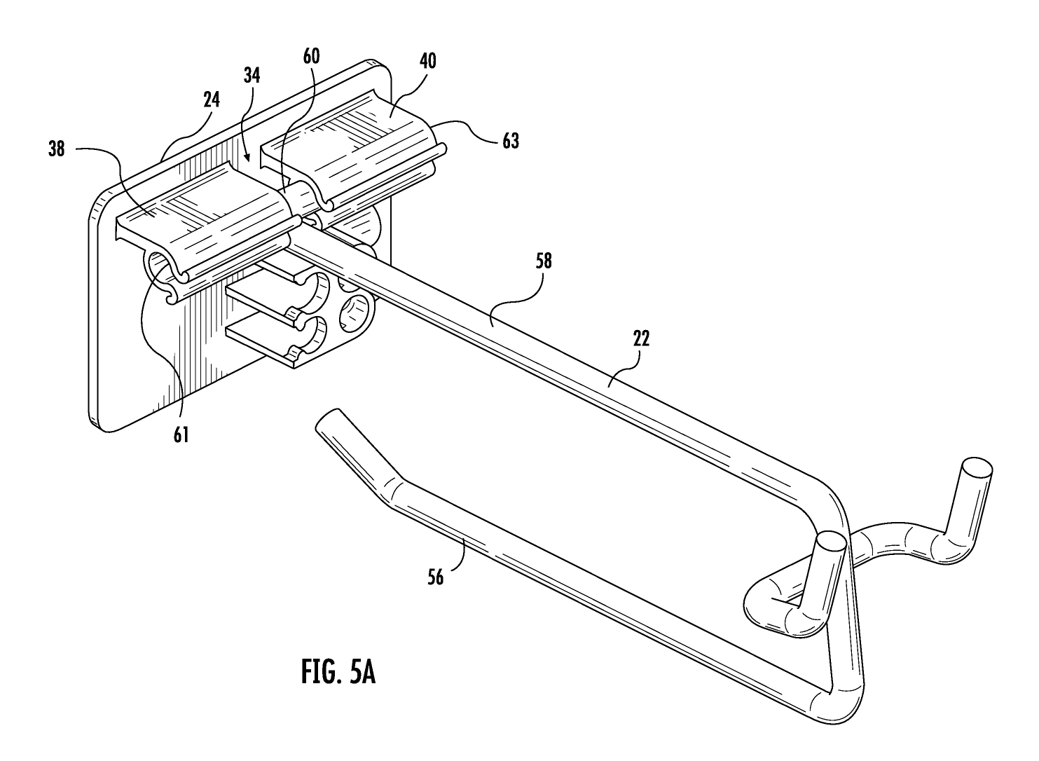

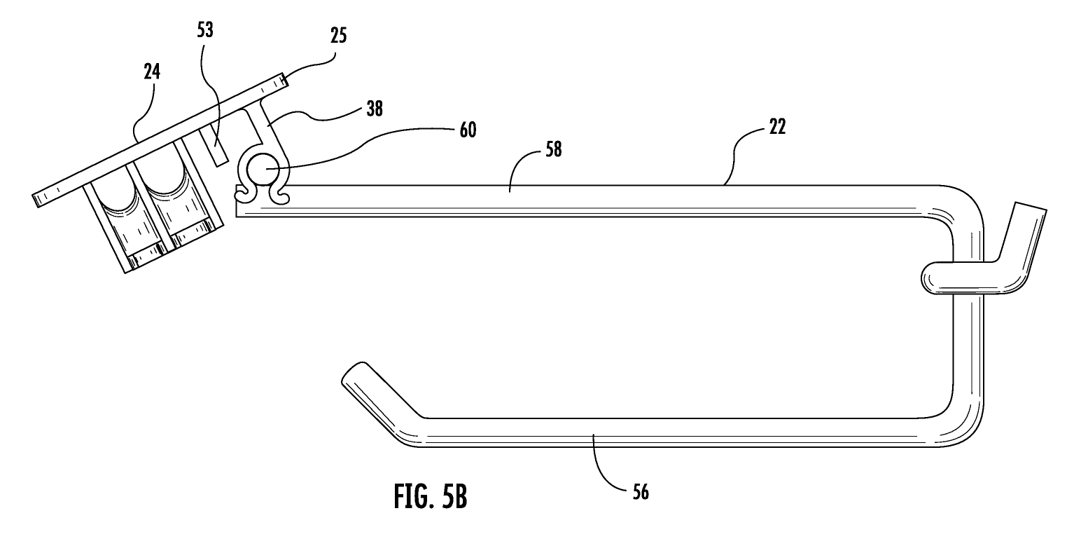

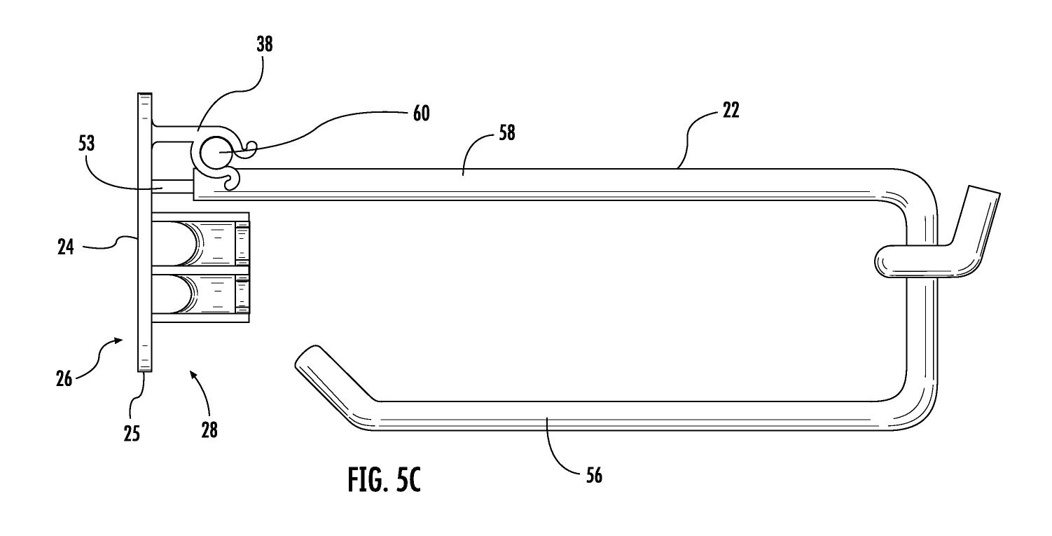

With reference to FIGS. 5 and 5A, in one embodiment, the display hook 22 includes a lower extension 56 configured to support products displayed and/or for sale and an upper extension 58 spaced apart from the lower extension 56. Coupled to the upper extension 58 is a coupling portion 60 extending generally perpendicularly to the upper extension 58 such that the upper extension 58 and the coupling portion 60 form a generally “T” shape. In one embodiment, the upper extension 58 and the coupling portion 60 are both generally cylindrical. In one embodiment, the coupling portion 60 is located on top of the upper extension 58. In other embodiments, the coupling portion 60 may be located in other suitable locations relative to the upper extension 58. As illustrated in FIGS. 5 and 5A, in one embodiment, the coupling portion 60 extends from a first end 61 located on a first side of the upper extension 58 to a second end 63 located on a second side of the upper extension 58 opposite the first side.

As illustrated in FIGS. 5 and 5A, in one embodiment, to couple the label holder 24 to the wire hook 22, the left portion of the coupling portion 60 is located in the channel 52 of the left clip 38 and the right portion of the coupling portion 60 is located in the channel 52′ of the right clip 40. In one embodiment, with the label holder 24 coupled to the coupling portion 60 the upper extension 58 is generally lower than and aligned with the gap 42.

The label holder 24 is configured to be coupled to the coupling portion 60. In one embodiment, the upper 48 and lower 50 legs are configured to deflect away from one another to allow the left portion of the coupling portion 60 into the channel 52. Similarly, the upper 48′ and lower 50′ legs are configured to deflect away from one another to allow the right portion of the coupling portion 60 into the channel 52′. Once the coupling portion 60 is located in the channels 52 and 52′, the upper 48 and lower 50 legs are configured to return toward one another and the upper 48′ and lower 50′ legs are configured to return toward one another to maintain the coupling portion 60 in the channels 52 and 52′, coupling the label holder 24 to the coupling portion 60. In one embodiment, the channels 52 and 52′ are sized to receive the coupling portion 60 and the legs 48, 48′, 50, and 50′ are configured such that the gaps 54 and 54′ are sized such that the coupling portion 60 is deterred from accidental removal from the channels 52 and 52′.

In one embodiment, as is illustrated in FIG. 5B, the label holder 24 is configured to be rotated about the coupling portion 60 with the coupling portion 60 located in the channels 52 and 52′. For example, the bottom portion of the plate portion 25 may be moved upwardly and away from the lower extension 56. In another embodiment, rotation of the bottom portion of the plate portion 25 of the label holder 24 toward the lower extension 56 may be prevented. In another embodiment, the label holder 24 may be configured such that rotation of the label holder is deterred.

With reference to FIG. 4A, 4B, and 5C, projecting from the coupling side 28 of the plate portion 25 is a stop wall 53. The stop wall 53 is located generally below the gap 42 between the left clip 38 and the right clip 40, generally above the second coupling portion 36. As illustrated in FIG. 5C, the stop wall 53 is configured to contact the upper extension 58 to limit the rotation of the label holder 24 about the coupling portion 60 in one direction. In one embodiment, the plate portion 25 is configured such that the display side 26 is configured to be viewed by a potential customer when the stop wall 53 contacts the upper extension 58.

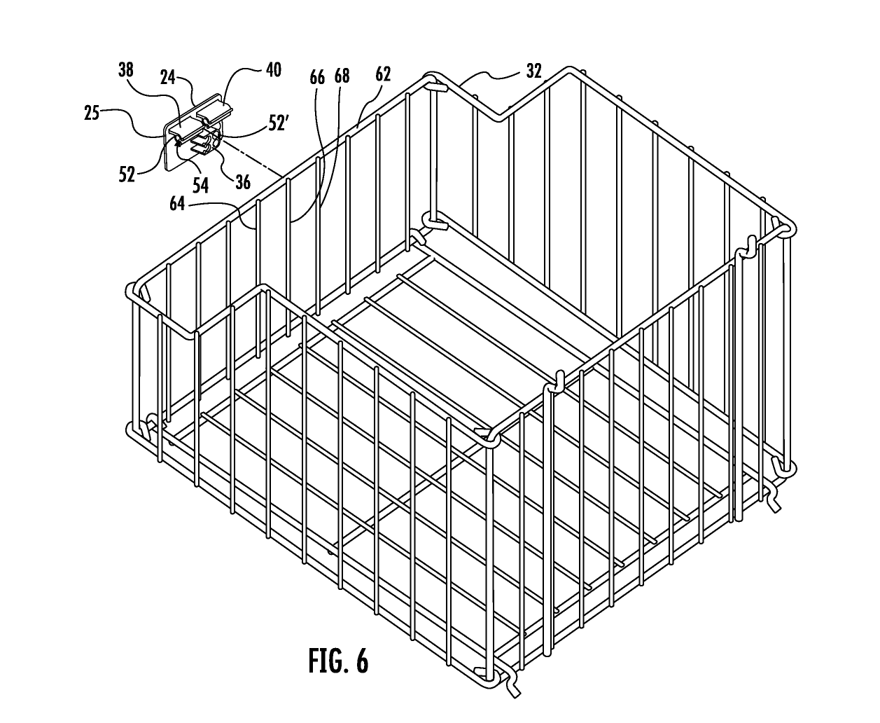

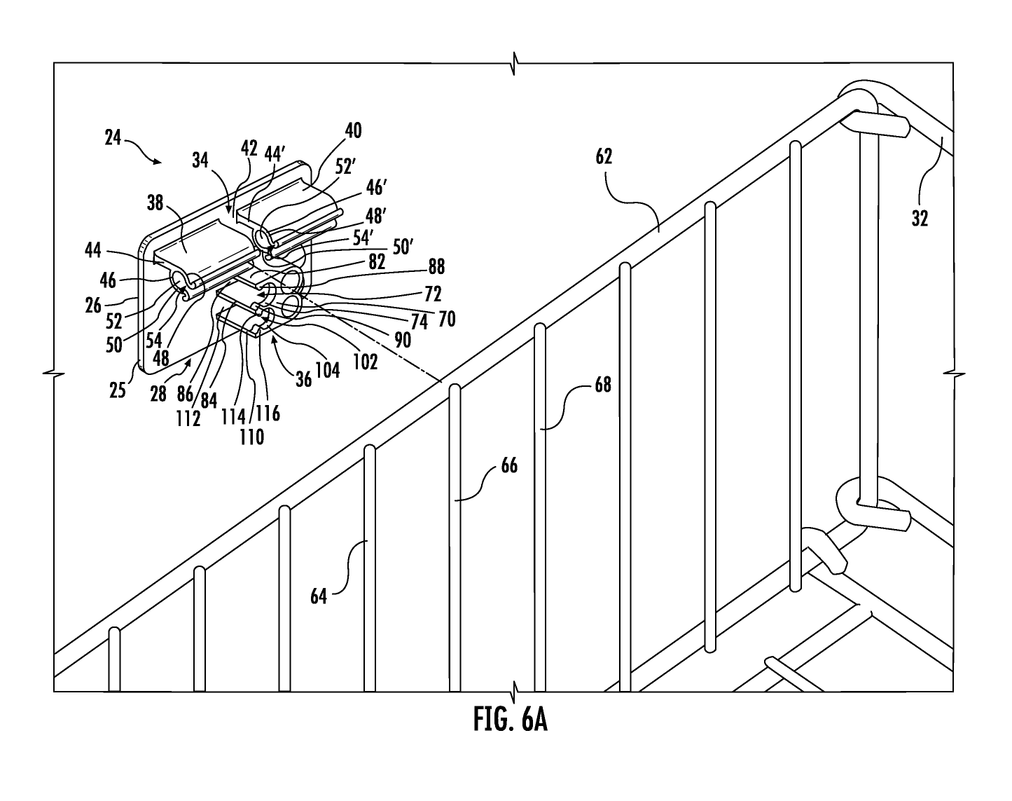

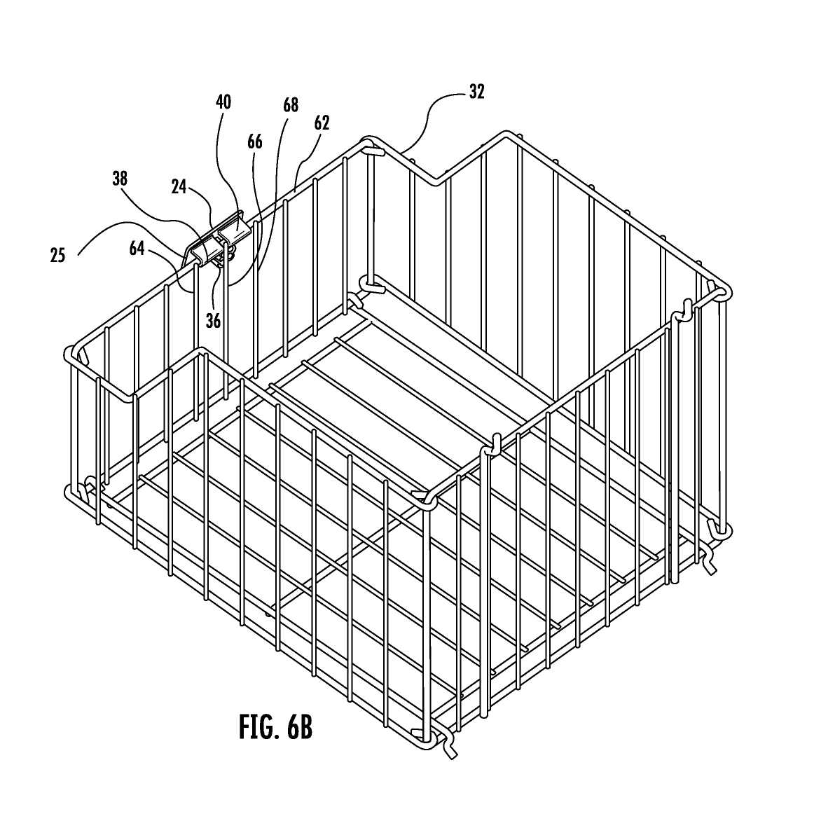

With reference to FIGS. 6-6B, in one embodiment, the first coupling portion 34 is configured to couple the label holder 24 to another display, illustrated in FIGS. 6 and 6A as a wire basket 32. In one embodiment, the wire basket 32 includes a front, top bar 62 to which the label holder 24 is coupled and a plurality of vertical bars extending downwardly from the top bar 62. In other embodiments, the label holder 24 may be coupled to any other suitable portion of the wire basket 32.

With further reference to FIGS. 6-6B, in one embodiment, the label holder 24 may be coupled to the wire basket 32. The left clip 38 is aligned with a portion of the top bar 62 between a first vertical bar 64 and a second vertical bar 66 adjacent the first vertical bar 64. The right clip 40 is aligned with a portion of the top bar 62 between the second vertical bar 66 and a third vertical bar 68 adjacent the second vertical bar 66. The portion of the top bar 62 between the first vertical bar 64 and the second vertical bar 66 is moved into the channel 52 through the gap 54, the upper 48 and lower legs 50 being displaced away from one another to allow the top bar 62 into the channel 52 and returning toward one another with the top bar 62 in the channel 52. In one embodiment, concurrently the portion of the top bar 62 between the second vertical bar 66 and the third vertical bar 68 is moved into the channel 52′ through the gap 54′, the upper 48′ and lower 50′ legs being displaced away from one another to allow the top bar 62 into the channel 52′ and returning toward one another with the top bar 62 in the channel 52′. In one embodiment, the top bar 62 is located in the channels 52 and 52′ by moving the label holder 24 toward the top bar 62. In one embodiment, with the top bar 62 located in the channels 52 and 52′, the second vertical bar 66 is located against the second coupling portion 36 and the plate portion 25 is non-parallel with the vertical bars 64, 66, and 68.

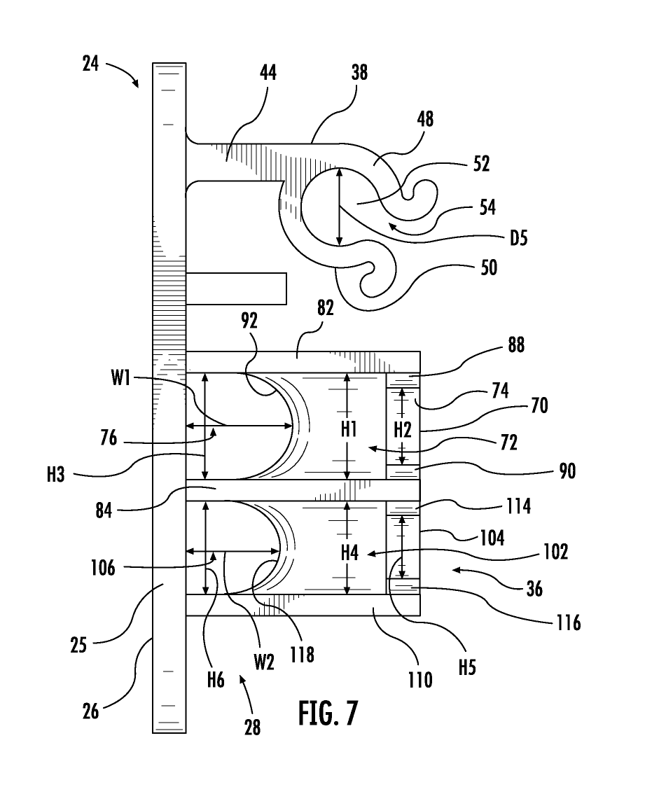

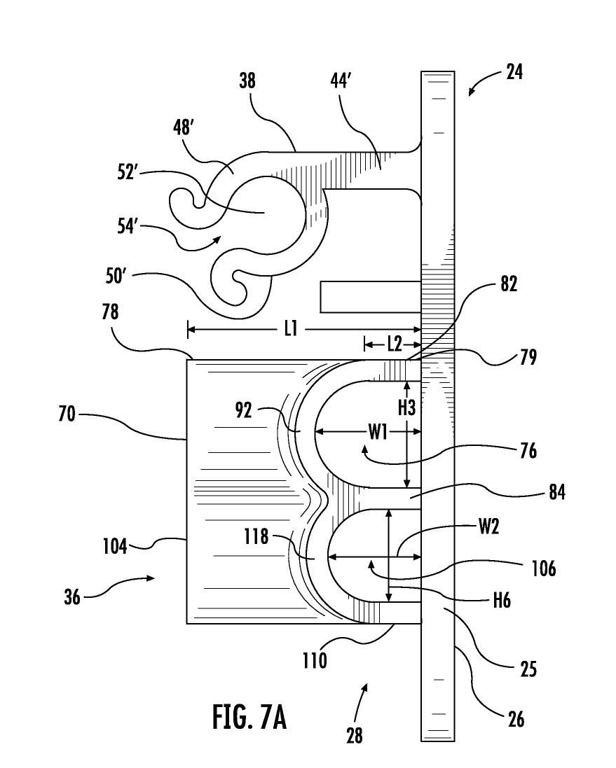

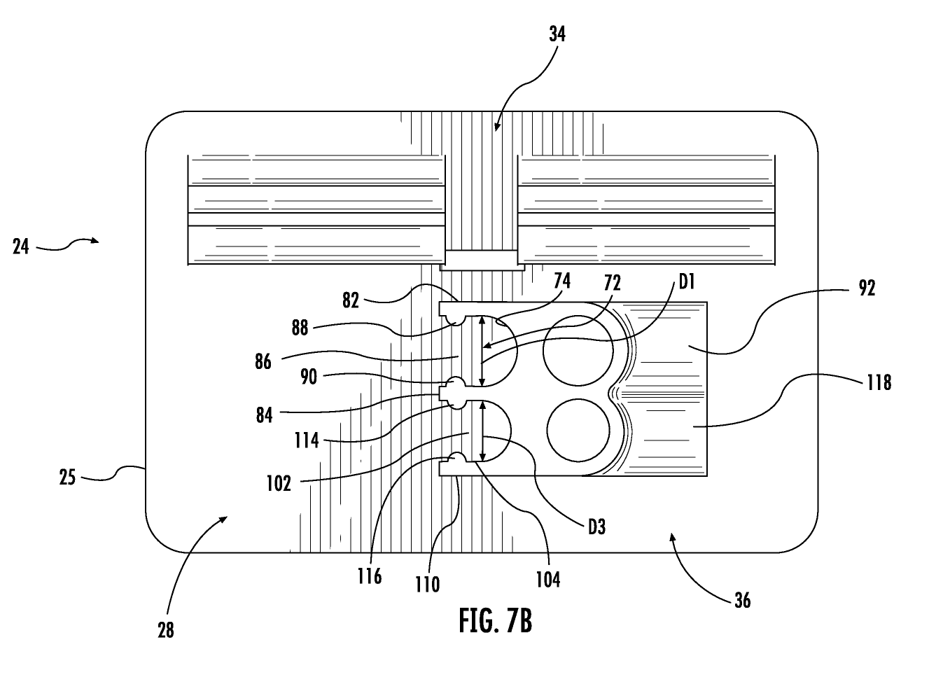

With reference to FIG. 7, in one embodiment the channel 52 has a diameter D5. In one embodiment, the diameter D5 of the channel 52 is between approximately 0.1 inches and approximately 0.2 inches. In another embodiment, the diameter D5 of the channel 52 is between approximate 0.125 inches and approximately 0.175 inches. In another embodiment, the diameter D5 of the channel 52 is approximately 0.149 inches. In one embodiment, the channel 52′ is sized approximately the same as the channel 52. In one embodiment, the channels 52 and 52′ are configured to receive a coupling portion 60 with a diameter of between approximately 0.1 inches and approximately 0.2 inches. In another embodiment, the channels 52 and 52′ are configured to receive a coupling portion 60 with a diameter of approximately 0.149 inches.

With reference to FIGS. 4 and 7 generally, in one embodiment, the second coupling portion 36 is configured to couple the label holder 24 to embodiments of L-bend hooks of different sizes, as will be explained further below.

With reference to FIGS. 4, 4B, and 7-7B, the second coupling portion 36 extends away from the plate portion 25 to an end wall 70. In one embodiment, the second coupling portion 36 is located vertically lower than the first coupling portion 34 on the plate portion 25. In other embodiments, the second coupling portion 36 may be located in other suitable locations relative to the first coupling portion 34. The second coupling portion 36 defines a first channel 72 extending along an axis generally perpendicular to the plate portion 25 from the surface of the plate portion 25 to an aperture 74 in the end wall 70. In one embodiment, the first channel 72 is generally below the gap 42, generally horizontally centered relative to the plate portion 25. In one embodiment, the aperture 74 in the end wall 70 has a diameter D1.

With further reference to FIGS. 4, 4B, and 7-7B, in one embodiment, the second coupling portion 36 defines a second channel 76 extending from the first channel 72 proximate the plate portion 25 along plate portion 25. The second coupling portion 36 includes a top wall 82 extending between the plate portion 25 and the end wall 70. The top wall 82 includes a first portion 78 proximate the aperture 74 that extends a first length L1 away from the plate portion 25. The top wall 82 also includes a second portion 79 that extends a second distance L2 away from the plate portion 25. A transition portion 81 extends between the first and second portions 78 and 79. In one embodiment, the length L1 of the first portion 78 is greater than the length L2 of the second portion 79.

With further reference to FIGS. 4, 4B, and 7-7B, in one embodiment, the second coupling portion 36 also includes a middle wall 84 spaced apart from the top wall 82, the top wall 82 and middle wall 84 being located on opposite sides of the first channel 72. In one embodiment, the middle wall 84 is shaped similarly to the top wall 82.

With further reference to FIGS. 4 and 7, the top wall 82 and the middle wall 84 define a gap 86 therebetween on the left side of the second coupling portion 36 providing access to the first channel 72. In one embodiment, the gap 86 has a height H1 (see FIG. 7). Extending from the top wall 82 proximate the end wall 70 into the gap 86 toward the middle wall 84 is a first projection 88. Extending from the middle wall 84 proximate the end wall into the gap 86 toward the top wall 82 is a second projection 90. In one embodiment, there is a distance H2 between the lower peripheral edge of the first projection 88 and the upper peripheral edge of the second projection 90 (see FIG. 7). In one embodiment, the distance H2 is less than the height H1. In one embodiment, the distance H2 is between approximately 0.1 inches and 0.3 inches. In another embodiment, the distance H2 is between approximately 0.15 inches and approximately 0.25 inches. In another embodiment, the distance H2 is approximately 0.2 inches. In another embodiment, the distance H2 is approximately 0.205 inches.

With reference to FIGS. 7 and 7A, in one embodiment, the second channel 76 is defined by the plate portion 25, the top wall 82, the middle wall 84, and a rounded wall portion 92 extending between the top wall 82 and the middle wall 84. The second channel 76 has a minimum width, e.g., distance between the plate portion 25 and the rounded wall portion 92, proximate the top wall 82 and proximate the middle wall 84. The width of the second channel 76 increases to a maximum width W1 proximate the midpoint between the top wall 82 and the middle wall 84. The second channel 76 has a height H3 proximate the plate portion 25 and a reduced height proximate the rounded wall portion 92. In one embodiment, the height H3 is generally the same as the height H1 (see FIG. 7).

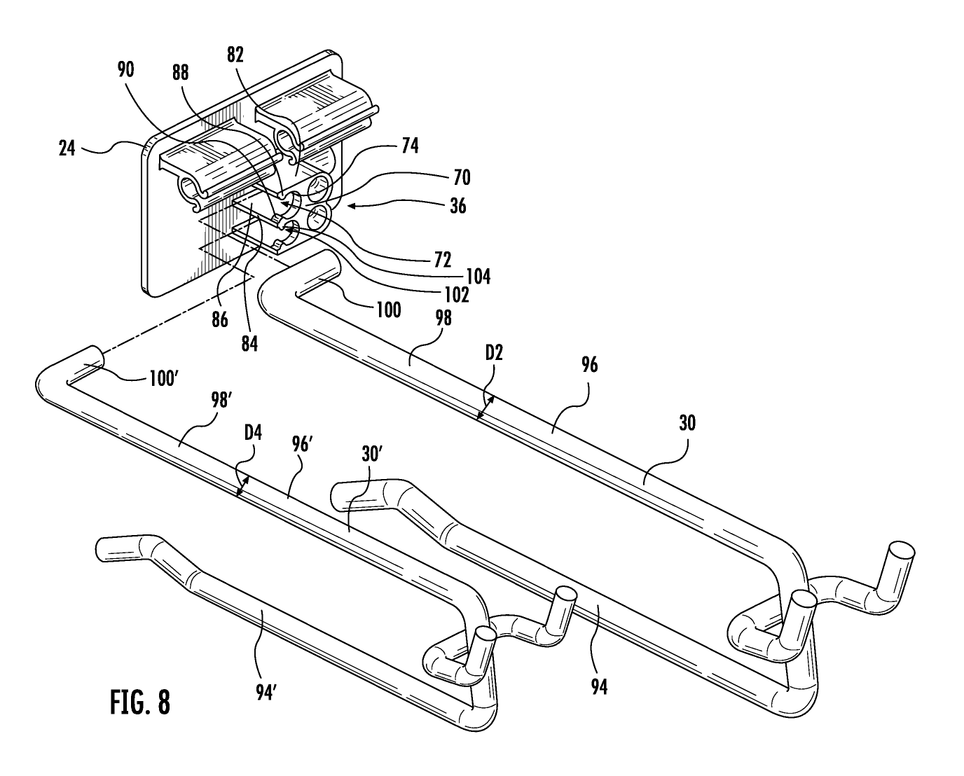

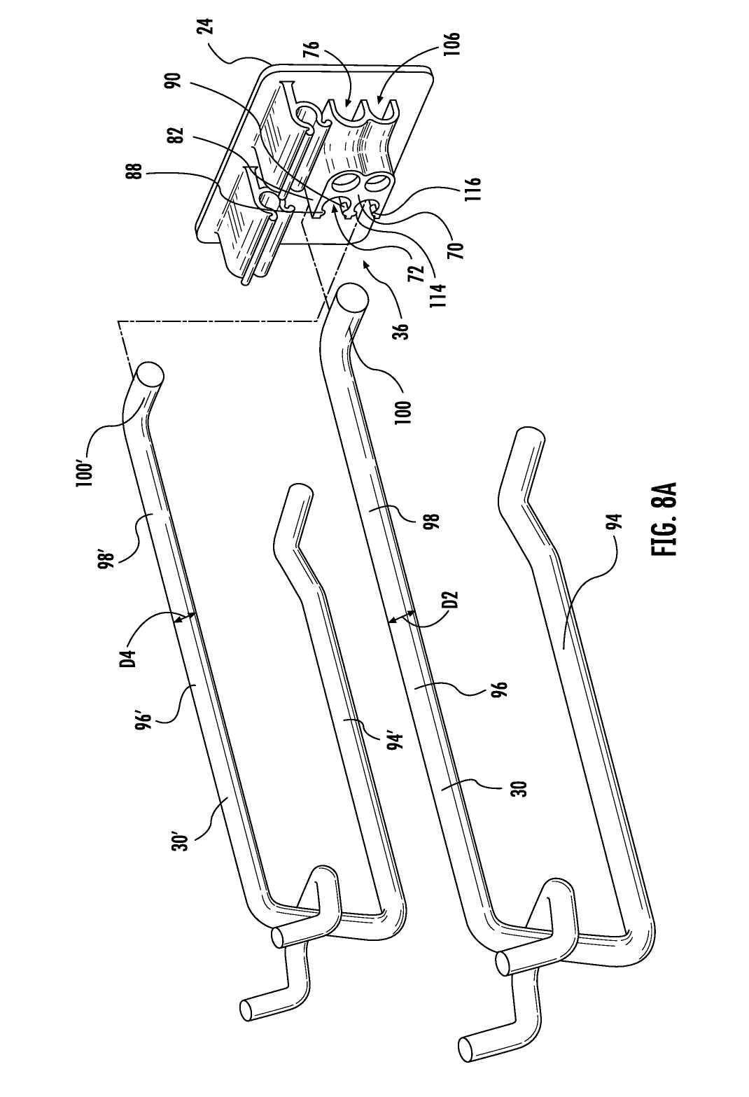

With reference to FIG. 8, in one embodiment, the second coupling portion 36 is configured to couple the label holder 24 to an embodiment of an L-bend wire hook 30. The L-bend wire hook 30 includes a lower extension 94 on which products for sale may be supported and an upper extension 96 spaced apart from the lower extension 94. The upper extension 96 includes a first portion 98 extending in a first direction and a second portion 100 extending from an end of the first portion 98 generally perpendicular to the first portion 98. In one embodiment, the second portion 100 extends in only one direction from the first portion 98. In the embodiment in FIG. 8, the second portion 100 extends to the right of the first portion 98. In other embodiments, a second portion may extend in any suitable direction.

With reference to FIGS. 7, 8, 8A, 9, and 9A to couple the label holder 24 to the L-bend wire hook 30, the second coupling portion 36 is located to the right of the upper extension 96 with the second portion 100 of the upper extension 96 generally aligned with the second channel 76. In one embodiment, the upper extension 96 has a diameter D2. In one embodiment, the diameter D2 is generally the same as the width W1 and the height H3 of the second channel 76, less than the distance H1 between the top wall 82 and the middle wall 84, but greater than the distance H2 between the lower peripheral edge of the first projection 88 and the upper peripheral edge of the second projection 90. In another embodiment, the diameter D2 is less than the width W1 and height H3 of the second channel 76, less than the distance H1 between the top wall 82 and the middle wall 84, but greater than the distance H2 between the lower peripheral edge of the first projection 88 and the upper peripheral edge of the second projection 90. The label holder 24 is moved to the left relative to the L-bend wire hook 30 with the second portion 100 of the upper extension 96 passing through the gap 86 and into the second channel 76. The first portion 98 of the upper extension 96 contacts the first and second projections 88 and 90 and deflects the top 82 and middle 84 walls away from one another until the first portion 98 is permitted to pass therebetween to be located in the first channel 72, where the first portion 98 projects through the aperture 74 in the end wall 70. Once the first portion 98 is located in the first channel 72, the upper 82 and middle 84 walls and first 88 and second 90 projections return toward one another. The upper extension 96 is sized to be retained in the aperture 74 with the first 88 and second 90 projections deterring accidental removal of the label holder 24 from the upper extension 96. In one embodiment, the diameter D2 of the upper extension 96 is equal to the diameter D1 of the aperture 74. In another embodiment, the diameter D2 of the upper extension 96 is less than the diameter D1 of the aperture 74 and greater than the distance H2 between the lower peripheral edge of the first projection 88 and the upper peripheral edge of the second projection 90. In one embodiment, the first portion 98 of the upper extension 96 located in the first channel 72 deters rotation of the label holder 24 about the second portion 100 of the upper extension 96. In one embodiment, the second portion 100 of the upper extension 96 located in the second channel 76 deters rotation of the label holder 24 about the first portion 98 of the upper extension 96.

With further reference to FIGS. 4, 4B, and 7-7B, the second coupling portion 36 defines a third channel 102 below the first channel 72 and extending along an axis generally perpendicular to the plate portion 25 from the surface of the plate portion 25 to an aperture 104 in the end wall 70. In one embodiment, the third channel 102 is generally below the gap 42, generally horizontally centered relative to the plate portion 25. In one embodiment, the aperture 104 in the end wall 70 has a diameter D3 (see FIG. 4). In one embodiment, the diameter D3 of the aperture 104 is smaller than the diameter D1 of the aperture 74.

With further reference to FIGS. 4, 4B, and 7-7B, the second coupling portion 36 defines a fourth channel 106 extending from the third channel 102 proximate the plate portion 25 extending along the plate portion 25 to an aperture 108 in the right wall 80 of the second coupling portion 36. The second coupling portion 36 includes a bottom wall 110 extending between the plate portion 25 and the end wall 70. In one embodiment, the bottom wall 110 is shaped similarly to the middle wall 84 and the top wall 82. The middle wall 84 and the bottom wall 110 define a gap 112 (see FIG. 4) therebetween on the left side of the second coupling portion 36 providing access to the third channel 102. In one embodiment, the gap 112 has a height H4 (see FIG. 7). In one embodiment, the height H4 of the gap 112 is less than the height H1 of the gap 86.

Extending from the middle wall 84 proximate the end wall 70 into the gap 112 toward the bottom wall 110 is a third projection 114. Extending from the bottom wall 110 proximate the end wall 70 into the gap 112 toward the middle wall 84 is a fourth projection 116. In one embodiment, there is a distance H5 between the lower peripheral edge of the third projection 114 and the upper peripheral edge of the fourth projection 116. In one embodiment, the distance H5 is less than the height H4. Additionally, in one embodiment, the distance H5 is less than the distance H2 between the lower peripheral edge of the first projection 88 and the upper peripheral edge of the second projection 90.

With reference to FIGS. 7 and 7A, in one embodiment, the fourth channel 106 is defined by the plate portion 25, the middle wall 84, the bottom wall 110, and a rounded wall portion 118 extending between the middle wall 84 and the bottom wall 110. The fourth channel 106 has a minimum width, e.g., distance between the plate portion 25 and the rounded wall portion 118, proximate the middle wall 84 and proximate the bottom wall 110. The width of the fourth channel 106 increases to a maximum width W2 proximate the midpoint between the middle wall 84 and the bottom wall 110. The fourth channel 106 has a height H6 proximate the plate portion 25 and a reduced height proximate the rounded wall portion 118. In one embodiment, the height H6 is generally the same as the height H4 (see FIG. 7). In one embodiment, the height H6 of the fourth channel 106 is less than the height H3 of the second channel 76.

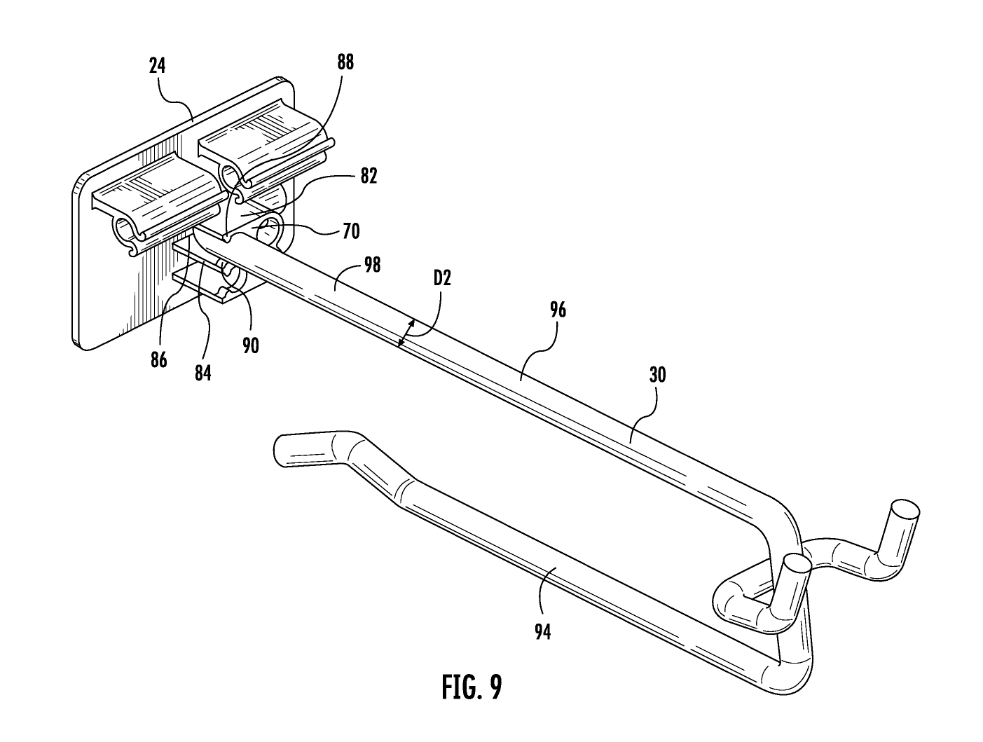

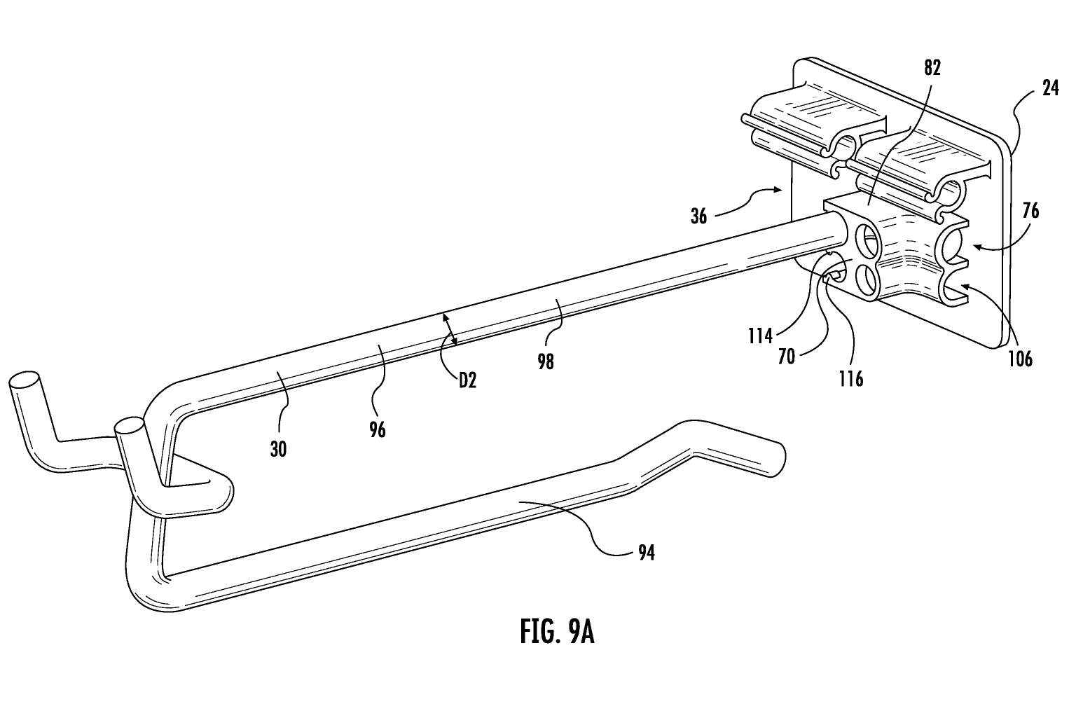

With reference to FIGS. 8-9A, in one embodiment, the second coupling portion 36 is configured to couple the label holder 24 to another embodiment of an L-bend wire hook 30′. The L-bend wire hook 30′ includes a lower extension 94′ on which products for sale may be supported and an upper extension 96′ spaced apart from the lower extension 94′. The upper extension 96′ includes a first portion 98′ extending in a first direction and a second portion 100′ extending from an end of the first portion 98′ generally perpendicular to the first portion 98′. In one embodiment, the second portion 100′ extends in only one direction from the first portion 98′. In the embodiment in FIG. 8, the second portion 100′ extends to the right of the first portion 98′. In one embodiment, the L-bend wire hook 30′ has features generally similar to the L-bend wire hook 30, except that the upper extension 96′ of the L-bend wire hook 30′ has a diameter D4 that is less than the diameter D2 of the upper extension 96.

With reference to FIGS. 7-9A, to couple the label holder 24 to the L-bend wire hook 30′, the second coupling portion 36 is located to the right of the upper extension 96′ with the second portion 100′ of the upper extension 96′ generally aligned with the fourth channel 106. In one embodiment, the diameter D4 is generally the same as the width W2 and the height H6 of the fourth channel 106, less than the distance H4 between the middle wall 84 and the bottom wall 110, but greater than the distance H5 between the lower peripheral edge of the third projection 114 and the upper peripheral edge of the fourth projection 116. In another embodiment, the diameter D4 is less than the width W2 and height H6 of the fourth channel 106, less than the distance H4 between the middle wall 84 and the bottom wall 110, but greater than the distance H5 between the lower peripheral edge of the third projection 114 and the upper peripheral edge of the fourth projection 116. In one embodiment, the distance H5 is between approximately 0.1 inches and 0.25 inches. In another embodiment, the distance H5 is between approximately 0.15 inches and approximately 0.2 inches. In another embodiment, the distance H5 is approximately 0.18 inches. In another embodiment, the distance H5 is approximately 0.185 inches.

With further reference to FIGS. 7-9A, the label holder 24 is moved to the left relative to the L-bend wire hook 30′ with the second portion 100′ of the upper extension 96′ passing through the gap 112 (see FIG. 4) and into the fourth channel 106. The first portion 98′ of the upper extension 96′ contacts the third and fourth projections 114 and 116 and deflects the middle 84 and bottom 110 walls away from one another until the first portion 98′ is permitted to pass therethrough to be located in the third channel 102. In the third channel 102, the first portion 98′ projects through the aperture 104 in the end wall 70. Once the first portion 98′ is located in the third channel 102, the middle 84 and bottom 110 walls and third 114 and fourth 116 projections return toward one another. The upper extension 96′ is sized to be retained in the aperture 104 with the third 114 and fourth 116 projections deterring accidental removal of the label holder 24 from the upper extension 96′. In one embodiment, the diameter D4 of the upper extension 96′ is equal to the diameter D3 (FIG. 4) of the aperture 104. In another embodiment, the diameter D4 of the upper extension 96′ is less than the diameter D3 of the aperture 104 and greater than the distance H5 between the lower peripheral edge of the third projection 114 and the upper peripheral edge of the fourth projection 116. In one embodiment, the first portion 98′ of the upper extension 96′ located in the third channel 102 deters rotation of the label holder 24 about the second portion 100′ of the upper extension 96′. In one embodiment, the second portion 100′ of the upper extension 96′ located in the fourth channel 106 deters rotation of the label holder 24 about the first portion 98′ of the upper extension 96′. Thus, in one embodiment the second coupling portion 36 provides for coupling the label holder 24 to L-shaped hooks of different diameters. In other embodiments, label holders are provided with second coupling portions with additional channels, e.g., fifth and sixth, seventh and eighth, etc., similar to first, second, third, and fourth channels described above, but of different sizes and apertures of various sizes configured to receive L-shaped hooks of different shapes and sizes, such that the label holders are configured to be coupled to additional L-shaped hooks.

In one embodiment, the diameter D2 of the upper extension 96 is between approximately 0.01 inches and approximately 0.5 inches. In another embodiment, the diameter D2 of the upper extension 96 is between approximately 0.1 inches and 0.3 inches. In another embodiment, the diameter D2 of the upper extension 96 is between approximately 0.2 inches and approximately 0.25 inches. In one embodiment, the diameter D2 of the upper extension 96 is approximately 0.212 inches.

In one embodiment, the diameter D4 of the upper extension 96′ is between approximately 0.01 inches and approximately 0.5 inches. In another embodiment, the diameter D4 of the upper extension 96′ is between approximately 0.1 inches and approximately 0.2 inches. In another embodiment, the diameter D4 of the upper extension 96′ is approximately 0.186 inches.

In one embodiment, the gaps 54 and 54′ (see, e.g., FIGS. 4 and 7) are a distance G1 of between approximately 0.01 inches and approximately 0.1 inches. In another embodiment, the gaps 54 and 54′ are a distance G1 of between approximately 0.03 inches and approximately 0.09 inches. In another embodiment, the gaps 54 and 54′ are a distance G1 of approximately 0.06 inches.

In one embodiment, label holders described above are able to attach to multiple different displays. In one embodiment, this may allow a retail setting to have a reduced amount of label holders, e.g., not require a different label holder for each different type of display. In one embodiment, label holders described above may be switched through multiple displays without removing and reapplying label information to other label holders configured to attach to only a single type of display.

In one embodiment, the plate holder 25 is configured to accept label holder attachments for holding non-adhesive labels.

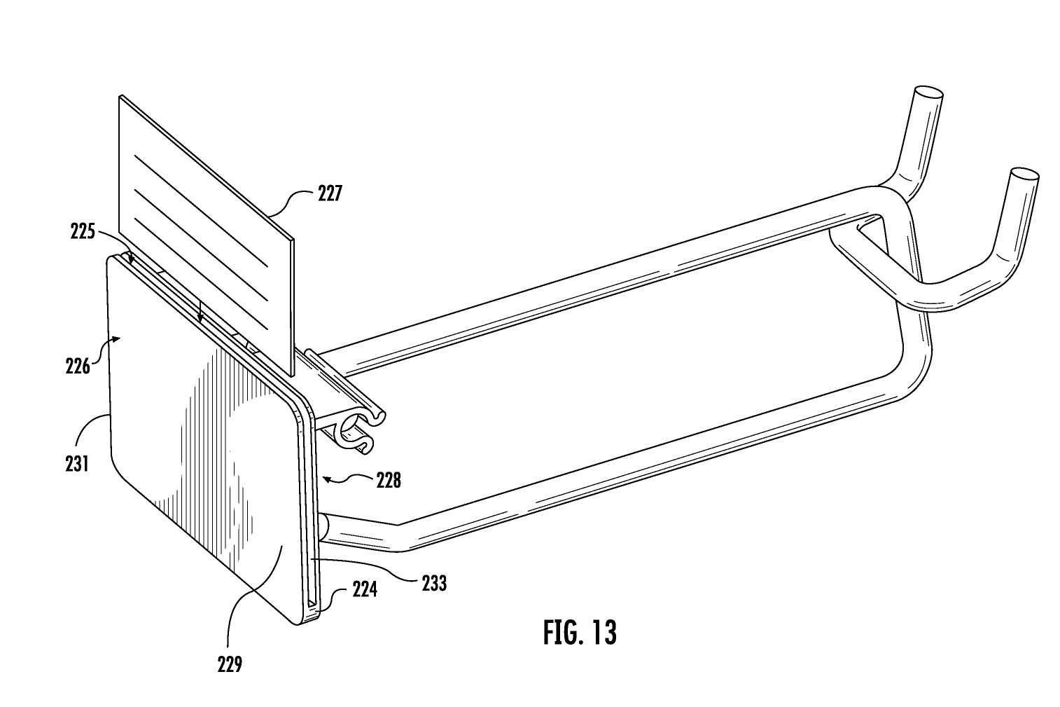

With reference to FIG. 13, another embodiment of a label holder 224 is illustrated. The label holder 224 has many features similar to the label holder 24 described above, therefore, differences from the label holder 24 are the focus of the description of the label holder 224. As in the previous embodiment, the label holder 224 includes a display side 226, configured to display information and a coupling side 228 configured to couple the label holder 224 to various displays, as in the embodiment described above. However, the label holder 224 defines a pocket 225 in which a label 227 may be located to hold the label 227 in place for display. In one embodiment, the front wall 229 may be transparent or translucent to allow the label 227 located in the pocket 225 to be seen. The label 227 may be removed from the pocket 225 and replaced. In one embodiment, the pocket 225 may have open sides at either end 231, 233 of the front wall 229. In another embodiment, the sides of the pocket 225 may be closed.

In one embodiment, embodiments of label holder may be formed from plastic, e.g., polypropylene, polyethylene, polystyrene, polyvinyl chloride, PTFE, nylon, PET, HDPE, polylactic acid (PLA), etc. In other embodiments, embodiments of label holders may be formed from various suitable metals, alloys, etc. In other embodiments, label holders may be formed from other suitable materials. In one embodiment, a label holder is unitarily formed. In other embodiments, the coupling portions may be formed separately and coupled to the plate portion by any suitable mechanism, e.g., adhesive, fastener, etc.

In one embodiment, a label holder may be formed by molding, e.g., injection molding, other suitable types of molding, etc. In another embodiment, a label holder may be formed by machining, e.g., computer numerical control, etc., from, e.g., metal or any other suitable material. In another embodiment, a label holder may be formed by casting, e.g., metal casting, etc.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A label holder comprising:
a label portion including a display side configured to display a label and an attachment side;
a first coupling portion extending from the attachment side of the label portion configured to couple the label holder to a first display; and
a second coupling portion extending from the attachment side of the label portion configured to couple the label holder to a second display, the second display being different from the first display.

2. The label holder of claim 1, wherein the first coupling portion includes a clip defining a channel configured to receive a portion of a first display therein to couple the label holder to the first display.

3. The label holder of claim 1, wherein the first coupling portion includes a first clip defining a first channel and a second clip each defining a second channel, the first and second channels being generally aligned, the first and second clips spaced apart by a gap, the first and second clips configured to receive a coupling portion of a first display into the first and second channels, the coupling portion of the first display extending through the gap between the first and second clips.

4. The label holder of claim 3, wherein the label holder is rotatable about the coupling portion of the first display with the coupling portion of the first display located in the first and second channels.

5. The label holder of claim 1, wherein the second coupling portion defines a channel with a first portion extending generally perpendicularly to the label portion and a second portion extending from the first portion generally perpendicular to the first portion proximate the label portion.

6. The label holder of claim 5, wherein the second coupling portion includes first and second walls on opposite sides of the channel extending generally perpendicular to the label portion and defining between them a gap along a side of the first portion of the channel distal from the second portion of the channel, the gap providing axis to the first portion of the channel.

7. The label holder of claim 6, wherein the second coupling portion includes a first projection extending from the first wall toward the second wall into the gap; and
wherein the second coupling portion includes a second projection extending from the second wall toward the first wall into the gap.

8. The label holder of claim 1, wherein the second coupling portion defines a first channel and a second channel spaced apart from and extending generally parallel to the first channel, the first channel including a first portion extending generally perpendicular to the label portion and a second portion extending from the first portion generally perpendicular to the first portion proximate the label portion.

9. The label holder of claim 8, wherein the first portion of the first channel has a first diameter;
wherein the first portion of the second channel has a second diameter; and
wherein the first diameter is greater than the second diameter.

10. The label holder of claim 1, wherein the first coupling portion is configured to couple to a third display different from the second display.

11. A label holder comprising:
a label portion;
a first coupling portion extending from the label portion; and
a second coupling portion extending from the label portion to an end wall;
wherein the first coupling portion includes a first clip portion and a second clip portion spaced apart from the first clip portion, the first and second clip portions defining a first gap therebetween, the first clip portion defining a first channel, the second clip portion defining a second channel generally aligned with the first channel; and
wherein the second coupling portion defines a third channel extending along a first axis generally perpendicular to the label portion from the label portion to a first aperture in the end wall and a fourth channel extending from the third channel proximate the label portion and extending along a second axis generally parallel with the label portion.

12. The label holder of claim 11, wherein the label portion defines a pocket configured to receive a label.

13. The label holder of claim 11, wherein the second coupling portion defines a second gap providing a display access to the third and fourth channels.

14. The label holder of claim 13, wherein the second coupling portion includes a first projection and a second projection, the projections extending into the second gap from opposite sides of the second gap.

15. The label holder of claim 11, wherein the second coupling portion defines a fifth channel extending along a third axis generally parallel to the first axis and generally perpendicular to the label portion from the label portion to a second aperture in the end wall and a sixth channel extending from the fifth channel proximate the label portion and extending along a fourth axis generally parallel to the second axis.

16. The label holder of claim 15, wherein the first aperture in the end wall has a first diameter;
wherein the second aperture in the end wall has a second diameter; and
wherein the first diameter is greater than the second diameter.

17. The label holder of claim 15, wherein the second coupling portion defines a second gap providing access to the third and fourth channels to a display, the second gap spanning a first distance;
wherein the second coupling portion defines a third gap providing access to fifth and sixth channels to a display, the third gap spanning a second distance; and
wherein the first distance is greater than the second distance.

18. A method of providing multiple display arrangements comprising:
providing a first display including a first portion and a coupling portion extending generally perpendicularly to the first portion, the coupling portion extending from a first end on a left side of the first portion to a second end located on a right side of the first portion;
providing a second display including a first portion and a second portion extending generally perpendicularly to the first portion, the second portion extending from a first end proximate the first portion to a second end distal from the first portion;
providing a label holder configured to support a label and having a first coupling portion and a second coupling portion, the first coupling portion including a clip configured to receive the coupling portion of the first display and a second coupling portion defining a first channel and a second channel, the first channel being configured to receive the first portion of the second display, the second channel being configured to receive the second portion of the second display;
locating the coupling portion of the first display in the clip to couple the label holder to the first display;
removing the label holder from the first display; and
locating the first portion of the second display in the first channel of the second coupling portion and locating the second portion of the second display in the second channel of the second coupling portion to couple the label holder to the second display.

19. The method of claim 18, wherein the second coupling portion includes an end wall;
wherein the first channel extends to a first aperture in the end wall having a first diameter;
wherein the second coupling portion also includes a third channel extending generally parallel to the first channel to a second aperture in the end wall having a second diameter; and
wherein the diameter of the first aperture is greater than the diameter of the second aperture.

20. The method of claim 18, wherein the second coupling portion defines a gap configured to provide the first display access to the first and second channels.
